(19) United States
(12) Patent Application Publication
(10) Pub. No.: US 2026/0163423 A1
(43) Pub. Date: Jun. 11, 2026

(54) ROTOR, MOTOR, COMPRESSOR, AND REFRIGERATION CYCLE APPARATUS

(71) Applicant: Mitsubishi Electric Corporation, Tokyo (JP)

(72) Inventors: Koji YABE, Tokyo (JP); Yuji HIROSAWA, Tokyo (JP)

(21) Appl. No.: 18/707,188

(22) PCT Filed: Dec. 21, 2021
(86) PCT No.: PCT/JP2021/047253

§ 371 Date: May 3, 2024

(51) Int. Cl. H02K 1/276

(52) U.S. Cl. CPC H02K 1/276; H02K 2213/03

(57) ABSTRACT

A rotor includes a shaft, an annular rotor core fixed to the shaft and having a magnet insertion hole, and a permanent magnet disposed in a magnet insertion hole. The rotor core has a center hole which is formed at a center of the rotor core in a radial direction and in which the shaft is inserted, a plurality of slits formed around the center hole and each elongated in a circumferential direction of the rotor core, a rib formed between two of the plurality of slits, which are adjacent to each other in the circumferential direction, of the plurality of slits, and a groove portion formed to extend outward in the radial direction from the center hole. The groove portion is located on an inner side of the rib in the radial direction. A width T of the rib in the circumferential direction and a width W of the groove portion in the circumferential direction satisfy T>W.

### CROSS-REFERENCE TO RELATED APPLICATION

This application is a U.S. national stage application of PCT/JP 2021/047253 filed Dec. 21, 2021, the contents of which are incorporated herein by reference.

### TECHNICAL FIELD

The present disclosure relates to a rotor, a motor, a compressor, and a refrigeration cycle apparatus.

### BACKGROUND

In a rotor of a motor, a shaft is fixed in a center hole of a rotor core by shrink fitting. In the shrink fitting, the rotor core is heated to expand the center hole. Patent Reference 1, for example, discloses that cutout portions are formed along the inner periphery of a center hole in order to facilitate insertion of a shaft into the center hole.

### PATENT REFERENCE

Patent Reference 1: Japanese Patent Application Publication No. 2006-254662 (see FIG. 2)

However, if the cutout portions are formed along the center hole of the rotor core, the contact area between the rotor core and the shaft decreases, and fitting strength between the rotor core and the shaft decreases accordingly. If a shrink fitting margin is increased in order to increase the fitting strength, the time necessary for shrink fitting increases, and a fabrication process increases.

### SUMMARY

The present disclosure is made to solve the foregoing problem, and an object of the present disclosure is to increase fitting strength between a rotor core and a shaft.

A rotor according to the present disclosure includes a shaft, an annular rotor core fixed to the shaft and having a magnet insertion hole, and a permanent magnet disposed in the magnet insertion hole. The rotor core has a center hole which is formed at a center of the rotor core in a radial direction and into which the shaft is fitted, a plurality of slits formed around the center hole and each elongated in a circumferential direction of the rotor core, a rib formed between two of the plurality of slits, which are adjacent to each other in the circumferential direction, of the plurality of slits, a groove portion formed to extend outward in the radial direction from the center hole. The groove portion is located on an inner side of the rib in the radial direction. A width T of the rib in the circumferential direction and a width W of the groove portion in the circumferential direction satisfy T>W. The width T of the rib in the circumferential direction increases as a distance to the center hole decreases.

In the present disclosure, since the groove portion is formed on the inner side of the rib in the radial direction, the center hole can be uniformly expanded during heating of the rotor, and thus the shaft can be easily inserted in the center hole. In addition, since the width T of the rib and the width W of the groove portion satisfy T>W, a sufficient contact area is obtained between the shaft and the center hole, and thus fitting strength between the rotor core and the shaft can be increased.

### BRIEF DESCRIPTION OF THE DRAWINGS

FIG. 1 is a cross-sectional view illustrating a motor according to a first embodiment.

FIG. 2 is a cross-sectional view illustrating a rotor according to the first embodiment.

FIG. 3 is an enlarged view illustrating a portion including slits of a rotor core according to the first embodiment.

FIG. 4 is an enlarged view illustrating a portion including a rib of the rotor core according to the first embodiment.

FIG. 5 (A) and 5 (B) are diagrams for explaining a shrink fitting process of a comparative example.

FIG. 6 (A) and 6 (B) are diagrams for explaining a shrink fitting process of the first embodiment.

FIG. 7 is a longitudinal sectional view illustrating a Compressor to which the motor according to the first embodiment is applicable.

FIG. 8 is a diagram illustrating a refrigeration cycle apparatus including the compressor of FIG. 7.

### DETAILED DESCRIPTION

### First Embodiment

### (Configuration of Motor 100)

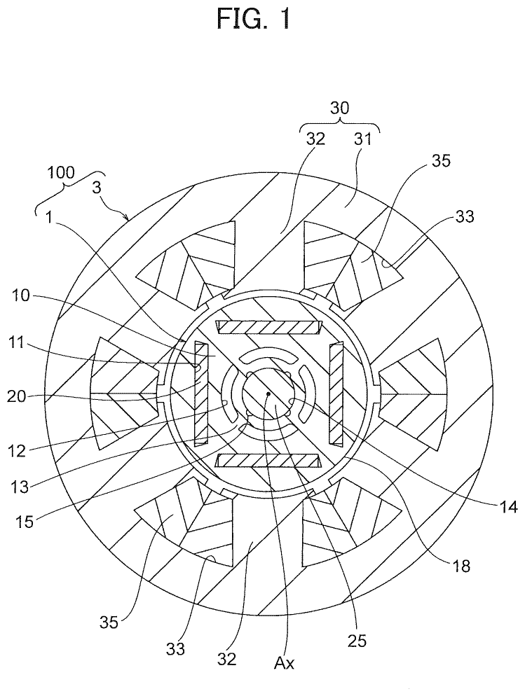

FIG. 1 is a transverse cross-sectional view illustrating a motor 100 according to a first embodiment. The motor 100 is an inner rotor type motor including a rotor 1 and an annular stator 3 surrounding the rotor 1. An air gap is formed between the stator 3 and the rotor 1.

In the following description, a rotation center axis of the rotor 1 is referred to as an axis Ax. A direction of the axis Ax is referred to as an “axial direction.” A circumferential direction about the axis Ax is referred to as a “circumferential direction,” and a radial direction about the axis Ax is referred to as a “radial direction.”

### (Configuration of Stator 3)

The stator 3 includes an annular stator core 30 and a coil 35 wound on the stator core 30. The stator core 30 is constituted by a plurality of electromagnetic steel sheets stacked in the axial direction. The thickness of each electromagnetic steel sheet is, for example, 0.1 mm or more and 1.0 mm or less.

The stator core 30 includes a yoke 31 extending in the circumferential direction and a plurality of teeth 32 extending inward from the yoke 31 in the radial direction. A slot 33 that is a space for accommodating the coil 35 is formed between adjacent ones of the teeth 32.

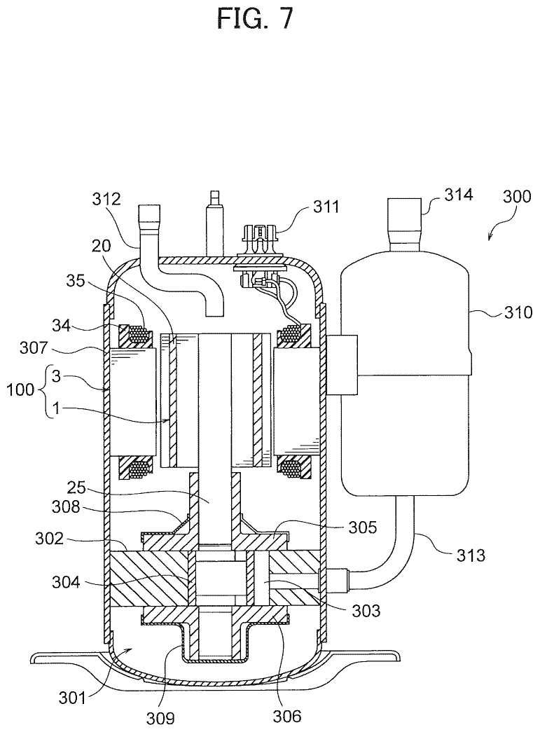

In this example, six teeth 32 are arranged at equal intervals in the circumferential direction. The number of teeth 32 is not limited to six, and any number of teeth 32 may be provided. An insulating portion is provided between the stator core 30 and the coil 35. The insulating portion is, for example, an insulator 34 illustrated in FIG. 7, an insulating film, or the like.

The coil 35 includes a conductor of copper or aluminum and an insulating film covering the conductor. The coil 35 is wound around the teeth 32 via the insulating portion. The method for winding the coil 35 may be concentrated winding r distributed winding.

### (Configuration of Rotor 1)

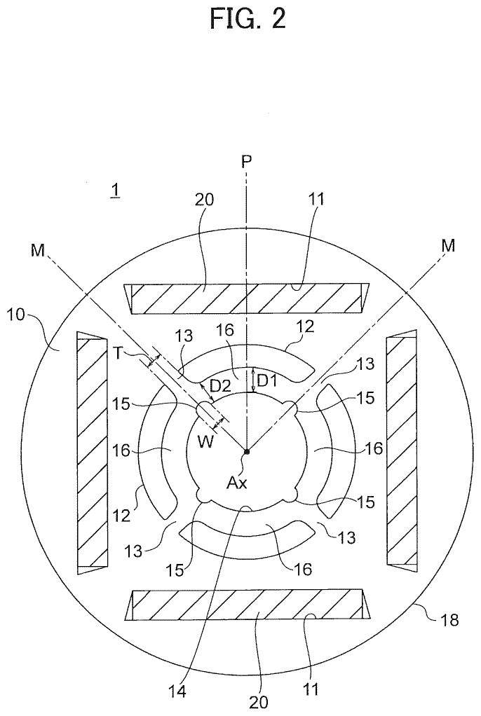

FIG. 2 is a transverse cross-sectional view illustrating the rotor 1. The rotor 1 includes a rotor core 10, permanent magnets 20, and a shaft 25 (FIG. 1). The rotor core 10 is constituted by a plurality of electromagnetic steel sheets stacked in the axial direction. The thickness of each electromagnetic steel sheet is, for example, 0.1 mm or more and 1.0 Mm or Less.

A plurality of magnet insertion holes 11 are formed along an outer periphery 18 of the rotor core 10 at equal intervals in the circumferential direction. One permanent magnet 20 is inserted in each of the magnet insertion holes 11. Each permanent magnet 20 has a thickness in the radial direction of the rotor core 10 and is magnetized in the thickness direction, Each permanent magnet 20 is made of a rare earth magnet. The rare-earth magnet is, for example, a neodymium magnet containing neodymium (Nd), iron (Fe), and boron (B), a samarium-iron-nitrogen magnet containing samarium (Sm), iron (Fe), and nitrogen (N), or the like.

The permanent magnet 20 in each of the magnet insertion holes 11 constitutes one magnetic pole. The center of the magnet insertion hole 11 in the circumferential direction serves as a magnetic pole center P. An inter-pole portion M is formed between adjacent ones of the magnet insertion holes 11.

In this example, the number of the magnet insertion holes 11 is four, and the number of the permanent magnets 20 is also four. Thus, the number of poles of the rotor 1 is four. However, the number of poles of the rotor 1, is not limited to four, and only needs to be two or more.

Although one permanent magnet 20 is disposed in each magnet insertion hole 11 in this example, two or more permanent magnets 20 may be disposed in each magnet insertion hole 11. Each magnet insertion hole 11 extends linearly in this example, but may extend in a V shape, for example,

The rotor core 10 has a center hole 14 at a center in the radial direction thereof. The center hole 14 is a circular hole to which the shaft 25 (FIG. 1) is fixed by shrink fitting. The shaft 25 is constituted by, for example, a metal.

A plurality of slits 12 each elongated in the circumferential direction are formed around the center hole 14 of the rotor core 10. The slits 12 extend in an arc shape in the circumferential direction and are arranged at equal intervals in the circumferential direction. The slits 12 are formed to make heat, which is applied from the center hole 14 side, less likely to transfer to the magnet insertion holes 11 during shrink fitting of the shaft 25 described later.

The number of the slits 12 is equal to the number of the magnet insertion holes 11, that is, four. The center of each slit 12 in the circumferential direction is aligned with the corresponding magnetic pole center P. The slits 12 are not limited to this arrangement, and the number of the slits 12 may be different from the number of the magnet insertion holes 11.

A rib 13 is formed between each two of the slits 12 adjacent to each other in the circumferential direction. The rib 13 is a core region extending in the radial direction. The number of the ribs 13 is equal to the number of the slits 12.

Groove portions 15 are formed to extend outward in the radial direction from the center hole 14. The groove portions 15 are formed on the inner side of the ribs 13 in the radial direction.

A width W of each groove portion 15 in the circumferential direction and a width T of each rib 13 in the circumferential direction satisfy W<T. In other words, the width W of the groove portion 15 in the circumferential direction is narrower than the width T of the rib 13 in the circumferential direction.

This is for the purpose of increasing fitting strength between the center hole 14 of the rotor core 10 and the shaft 25, as will be described later.

An inner peripheral core portion 16 that is an annular core portion is formed between the center hole 14 of the rotor core 10 and the slits 12 and the ribs 13 of the rotor core 10. The inner peripheral core portion 16 is a portion that is heated in a shrink fitting process described later to be expanded outward in the radial direction.

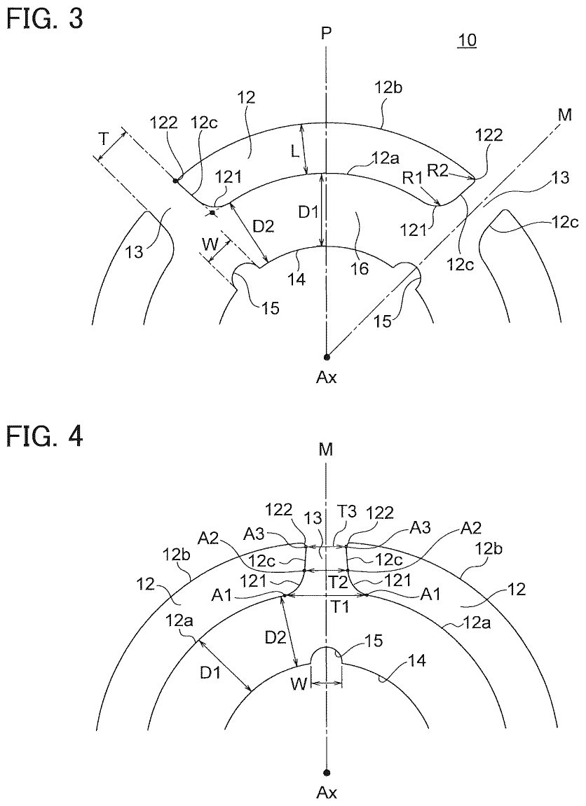

FIG. 3 is an enlarged view illustrating a portion including the slits 12 of the rotor core 10. Each of the slits 12 includes an inner edge 12a facing the center hole 14 of the rotor core 10, an outer edge 12b located on the outer side of the inner edge 128 in the radial direction, and side edges 12c each facing the corresponding rib 13.

Each of the inner edge 12a and the outer edge 12b of the slit 12 extends to form an arc shape in the circumferential direction about the axis Ax. Each slit 12 has a width L in the radial direction. The width L is a distance between the inner edge 12a and the outer edge 12b.

The width of the slit 12 in the radial direction is preferably uniform except for end portions of the slit 12 in the circumferential direction. However, the slit 12 is not limited to this example. In a case where the width of the slit 12 in the radial direction varies depending on the position in the circumferential direction, the width of a portion closest to the rib 13 is defined as the width L. Although corners of end portions of the slit 12 in the circumferential direction are rounded as described later, the width L corresponds to an interval between an intersection point of an extension line of

the inner edge 12a and an extension line of the side edge 12c and an intersection point of an extension line of the outer edge 12b and the extension line of the side edge 12c.

A curved corner 121 is formed on the center hole 14 side of the side edge 12c of each slit 12. A curved corner 122 is formed on the outer periphery 18 (FIG. 2) side of the side edge 12c. The curved corner 121 is also referred to as a first curved corner, and the curved corner 122 is also referred to as a second curved corner.

The curved corner 121 has a radius of curvature R1, and the curved corner 122 has a radius of curvature R2. The radius of curvature RI of the curved corner 121 and the radius of curvature R2 of the curved corner 122 satisfy R1>R2. The width L of the slit 12 in the radial direction and the radius of curvature R1 of the curved corner 121 satisfy R1>L/2.

FIG. 4 is an enlarged view illustrating a portion including the rib 13. The rib 13 is a portion sandwiched between two slits 12 in the circumferential direction. A boundary point between the curved corner 121 and the inner edge 12a of the slit 12 is defined as A1. A boundary point between the side edge 12c and the curved corner 121 is defined as A2. A boundary point between the side edge 12c and the curved corner 122 is defined as A3.

An interval between the boundary points A1 of two slits 12 in the circumferential direction is defined as T1. An interval between the boundary points A2 of two slits 12 in the circumferential direction is defined as T2. An interval between the boundary points A3 of two slits 12 in the circumferential direction is defined as T3. These intervals T1, T2, and T3 satisfy T1>T2≥T3. That is, the rib 13 has such a shape that the width T in the circumferential direction increases as the distance to the center hole 14 decreases.

The intervals T1, T2, and T3 preferably satisfy T1>T2≥T3>W, in a relationship with the width W of the groove portion 15 in the circumferential direction.

As illustrated in FIGS. 3 and 4, a distance D1 from the center hole 14 to the center of the slit 12 in the circumferential direction and a distance D2 from the center hole 14 to an end portion of the slit 12 in the circumferential direction satisfy D1<D2. The distance D1 is a distance from the center hole 14 to the center of the inner edge 12a of the slit 12 in the circumferential direction. The distance D2 is a distance from the center hole 14 to the boundary point A1 between the inner edge 12a and the curved corner 121 (FIG. 4).

### (Function)

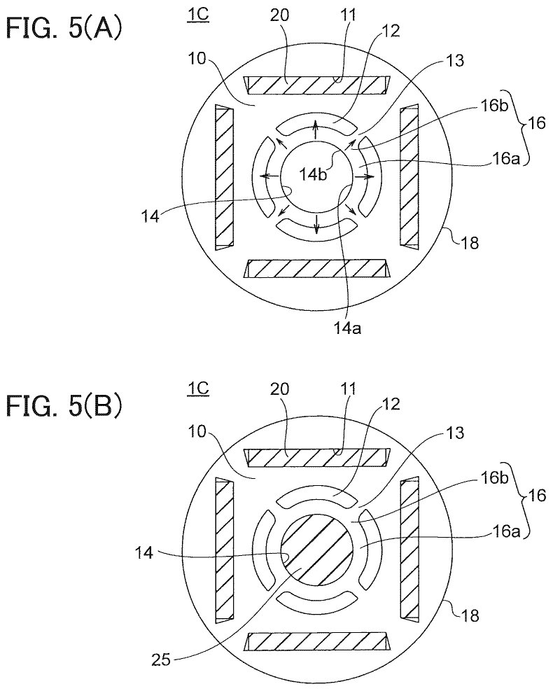

Next, function of the first embodiment will be described. FIG. 5 (A) and 5 (B) are diagrams illustrating a shrink fitting process of a rotor 1C in a comparative example. The rotor 1C of the comparative example is different from the rotor 1 of the first embodiment in that no groove portion 15 is formed around the center hole 14.

In shrink fitting of the shaft 25 in the rotor 10, the rotor core 10 is heated in a state where the permanent magnets 20 are attached to the rotor core 10 as illustrated in FIG. 5 (A) so as to increase the inner diameter of the center hole 14 by thermal expansion, Examples of the heating method include a method of placing the rotor core 10 in a heating furnace to heat the entire rotor core 10 and a method of heating the rotor core 10 from the center hole 14 side by high-frequency induction heating.

In a state where the inner diameter of the center hole 14 is increased, the shaft 25 at a lower temperature than the rotor core 10 is inserted in the center hole 14. After the shaft 25 is inserted in the center hole 14, the rotor core 10 is cooled at normal temperature Or low-temperature environment. Accordingly, the inner diameter of the center hole 14 of the rotor core 10 decreases, and the shaft 25 is fitted in the center hole 14 as illustrated in FIG. 5 (B).

In the case of using the heating furnace as a heating method, heat is transferred to the rotor core 10 from both of the center hole 14 and the outer periphery 18. On the other hand, in the case of using high-frequency induction heating, heat is supplied from the center hole 14, and thus heat is transferred from the center hole 14 toward the outer periphery 18 of the rotor core 10.

The temperature difference in the rotor core 10 occurs in either heating method, but tends to be larger in the high-frequency induction heating. Thus, before the temperature of the entire rotor core 10 increases, the temperature of the inner peripheral core portion 16 around the center hole 14 increases, and the inner peripheral core portion 16 is about to thermally expand.

The slits 12 are formed around the center hole 14, and the ribs 13 are each formed between adjacent ones of the slits 12. The inner peripheral core portion 16 can be considered to be divided into a first portion 16a located on the inner side of each slit 12 in the radial direction and a second portion 16b located on the inner side of each rib 13 in the radial direction.

The slit 12 is filled with a gas such as air, oil, or the like, and thus rigidity of the slit 12 is significantly lower

than that of the rotor core 10. Accordingly, the first portion 16a of the inner peripheral core portion 16, which is located on the inner side of the slit 12 in the radial direction, is easily deformed outward in the radial direction.

On the other hand, the second portion 16b of the inner peripheral core portion 16, which is located on the inner side of the rib 13 in the radial direction, is restricted from being deformed outward in the radial direction by the presence of the rib 13, and thus the second portion 16b is not easily deformed outward in the radial direction.

Consequently, when the rotor core 10 is heated from the center hole 14 side, the first portion 16a is expanded in the radial direction more greatly than the second portion 16b in the inner peripheral core portion 16. As a result, in the center hole 14, a first portion 14a located on the inner side of each slit 12 in the radial direction is expanded outward in the radial direction more greatly than a second portion 14b located on the inner side of each rib 13 in the radial direction. In other words, the center hole 14 is nonuniformly expanded, and circularity of the center hole 14 decreases.

In order to insert the shaft 25 in the center hole 14, the outer diameter of the shaft 25 needs to be smaller than a minimum inner diameter of the center hole 14. Thus, it is necessary to continue heating until the inner diameter of the second portions 14b of the center hole 14 becomes larger than the outer diameter of the shaft 25. That is, there is a problem that the heating time increases.

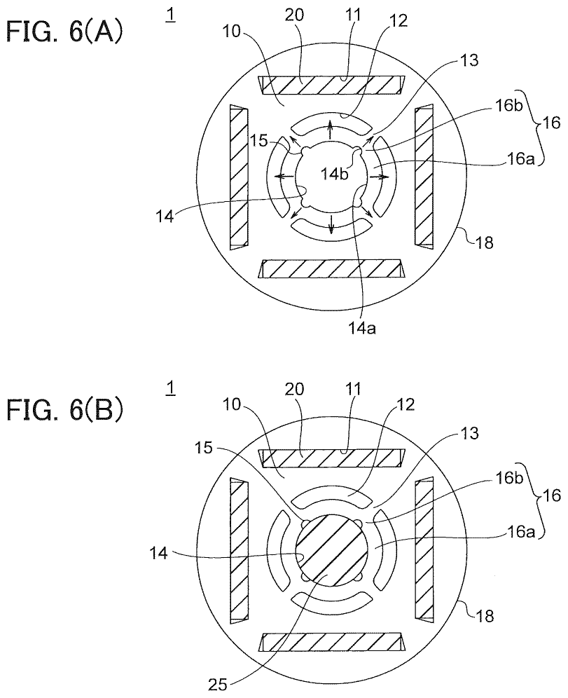

FIG. 6 (A) and 6 (B) are diagrams showing a shrink fitting process of the rotor 1 according to the first embodiment. In the rotor 1 according to the first embodiment, the groove portions 15 are formed to be continuous with the center hole 14 on the inner side of the ribs 13 in the radial direction.

In the first embodiment, the rotor core 10 is heated as illustrated in FIG. 6 (A) to increase the inner diameter of the center hole 14 by thermal expansion using the heating method similar to the comparative example. In a state where the inner diameter of the center hole 14 is increased, the shaft 25 at a lower temperature than the rotor core 10 is inserted in the center hole 14. When the temperature of the rotor core 10 returns to normal temperature, the inner diameter of the center hole 14 decreases and the center hole 14 and the shaft 25 are fixed to each other as illustrated in FIG. 6 (B).

During heating, a temperature difference occurs in the rotor core 10 as in the comparative example. In particular, in high-frequency induction heating in which the rotor core 10 is heated from the center hole 14 side, the temperature difference in the rotor core 10 tends to be large.

The first portions 16a of the inner peripheral core portion 16 are easily expanded in the radial direction, whereas the second portions 16b are not easily expanded outward in the radial direction. Accordingly, the first portions 14a of the center hole 14 are expanded outward in the radial direction more greatly than the second portions 14b.

However, in the first embodiment, the groove portion 15 is formed to be continuous with the center hole 14 on the inner side of each rib 13 in the radial direction. In other words, the second portions 14b of the center hole 14 are expanded outward in the radial direction beforehand. Thus, the shaft 25 can be inserted in the center hole 14 as long as the inner diameter of the first portions 14a of the center hole 14 is larger than the outer diameter of the shaft 25.

Since the first portions 14a of the center hole 14 are easily expanded outward in the radial direction as described above, the time for heating the rotor core 10 can be shortened. Accordingly, the time necessary for shrink fitting can be shortened. That is, the fabrication process of the rotor 1 can be shortened.

Here, in a case where the groove portions 15 are formed in the center hole 14, as the circumferential width (i.e., the width W in FIG. 2) of each groove portion 15 increases, the contact area between the center hole 14 and the shaft 25 decreases. As the contact area between the center hole 14 and the shaft 25 decreases, fitting strength between the rotor core 10 and the shaft 25 decreases. The decrease in fitting strength between the rotor core 10 and the shaft 25 can be suppressed by increasing a shrink fitting margin. However, in such a case, the heating time increases.

For this reason, in the first embodiment, as illustrated in FIG. 2, the width W of each groove portion 15 in the circumferential direction is made narrower than the width T of each rib 13 in the circumferential direction. Since the width W of the groove portion 15 is narrower than the width T of the rib 13 as described above, only portions (i.e., the second portions 14b) of the center hole 14 that are less likely to be expanded by thermal expansion can be expanded in the radial direction, and the other portions (i.e., the first portions 14a) can be in contact with the shaft 25. Accordingly, sufficient fitting strength can be obtained between the rotor core 10 and the shaft

Since the first portions 16a of the inner peripheral core portion 16 are easily deformed outward in the radial direction and the second portions 16b are not easily deformed outward in the radial direction as described above, stress tends to be concentrated on portions each between the first portion 16a and the second portion 16b (i.e., portions corresponding to end portions of the slits 12 in the circumferential direction). Consequently, due to plastic deformation of the inner peripheral core portion 16, inner diameter distortion of the center hole 14 may remain.

This affects work in the case of redoing shrink fitting. In general, when the rotor core 10 is insufficiently heated or when the temperature of the rotor core 10 decreases with the lapse of time after heating of the rotor core 10 until insertion of the shaft 25, there are cases where shrink fitting is redone by heating the rotor core 10 again.

When shrink fitting is redone, if the inner diameter distortion of the center hole 14 that has occurred in the previous heating remains, insertion of the shaft 25 in the center hole 14 is difficult, and it is necessary to perform change in conditions such as increase in the heating time for expanding the center hole 14. Thus, the inner diameter distortion of the center hole 14 is preferably as small as possible.

In order to suppress the inner diameter distortion of the center hole 14, it is effective to reduce stress concentration on portions corresponding to end portions of the slits 12 in the circumferential direction. For this reason, in the first embodiment, as illustrated in FIG. 3, the radius of curvature R1 of the curved corner 121 on the center hole 14 side of the side edge 12c of the slit 12 and the radius of curvature R2 of the curved corner 122 on the outer periphery 18 side of the side edge 12c satisfy R1>R2.

By making the radius of curvature RI of the curved corner 121 of the slit 12 large, stress can be dispersed, and inner diameter distortion of the center hole 14 can be suppressed. Accordingly, in redoing the shrink fitting described above, the shaft 25 can be easily inserted in the center hole 14.

In order to increase the radius of curvature R1 of the curved corner 121 as much as possible, in addition to satisfying R1>R2 as described above, it is preferable that the radius of curvature R1 of the curved corner 121 and the width L of the slit 12 in the radial direction satisfy R1>L/2. Accordingly, stress concentration in the inner peripheral core portion 16 can be further reduced.

In a case where an angle formed by the side edge 12c and the inner edge 12a of the slit 12 is an acute angle, stress tends to be concentrated on the curved corner 121 between the side edge 12c and the inner edge 12a. For this reason, in order to increase the angle formed by the side edge 12c and the inner edge 12a of the slit 12 as much as possible, the rib 13 is formed so that the width T of the rib 13 in the circumferential direction increases as the distance to the center hole 14 decreases.

That is, as described with reference to FIG. 4, the interval Tl between the boundary points A1, the interval T2 between the boundary points A2, and the interval T3 between the boundary points A3 of two slits 12 on both sides of the rib 13 satisfy T1>T2≥T3. Accordingly, stress concentration on the curved corner 121 can be reduced.

In addition, in the first embodiment, the distance D2 from the center hole 14 to the end portion of the slit 12 in the circumferential direction and the distance DI from the center hole 14 to the center of the slit 12 in the circumferential direction satisfy D1<D2.

As described above, in the inner peripheral core portion 16, a portion on which stress tends to be concentrated most is a portion corresponding to the end portion of the slit 12 in the circumferential direction. When the distance D2 from the center hole 14 to the end portion of the slit 12 in the circumferential direction is increased, the width of a portion of the inner peripheral core portion 16 on which stress tends to be concentrated most can be increased, and thus stress concentration can be reduced.

Next, Suppression of Demagnetization of the Permanent magnets 20 will be described. Each permanent magnet 20 is constituted by, for example, a rare earth magnet. The rare earth magnet has high magnetic force, and thus is advantageous for enhancing motor efficiency. On the other hand, the rare earth magnet has the property of susceptibility to demagnetization at high temperature, as compared to permanent magnets of other types (for example, ferrite magnets).

Thus, when the permanent magnets 20 are heated during heating of the rotor core 10, demagnetization of the permanent magnets 20 may occur. In particular, when heat applied to the center hole 14 of the rotor core 10 is transferred to the permanent magnets 20 in the magnet insertion holes 11, demagnetization of the permanent magnets 20 may occur.

In some cases, shrink fitting of the shaft 25 can be performed at a stage before magnetization of the permanent. magnets 20. Even in such cases, when the permanent magnets 20 are heated, performance and quality of the permanent magnets 20 may degrade.

For this reason, in the first embodiment, the slits 12 are formed around the center hole 14, and heat transfer paths from the center hole 14 to the magnet insertion holes 11 are made longer, so that a temperature rise of the permanent magnet 20 is suppressed. In particular, in a case where the ribs 13 are located on the inner side of the inter-pole portions M: in the radial direction, the heat transfer paths from the rib 13 to the magnet insertion holes 11 are the longest, and demagnetization of the permanent magnets 20 can be effectively suppressed.

The width T of the rib 13 in the circumferential direction represents the width at which heat is transferred, and the width L of the slit 12 in the radial direction represents a length in which heat is transferred. As the width T of the rib 13 in the circumferential direction decreases, heat is less likely to be transferred. As the width L of the slit 12 in the radial direction increases, heat is less likely to be transferred. Thus, it is preferable that the width T of the rib 13 in the circumferential direction is as small as possible and the width L of the slit 12 in the radial direction is as large as possible. For this reason, the width T of the rib 13 in the circumferential direction and the width L of the slit 12 in the radial direction preferably satisfy T≤L.

In this example, the number of the ribs 13 is equal to the number of the magnet insertion holes 11 (i.e., the number of poles). However, as long as the heat transfer path from the center hole 14 to each magnet insertion hole 11 can be made long, the number of the ribs 13 may be larger or smaller than the number of the magnet insertion holes 11. For example, one to three of the four ribs 13 illustrated in FIG. 2 may be provided. Also in such a case, the groove portion 15 is preferably formed on the inner side of each rib 13 in the radial direction.

The groove portion 15 only needs to be formed from the center hole 14 outward in the radial direction and on the inner side of the rib 13 in the radial direction. The shape of each groove portion 15 is semicircular in this example, but may be other shapes. In order to reduce stress concentration around the groove portion 15, the inner periphery of the groove portion 15 is preferably curved.

### (Advantages of Embodiment)

As described above, the rotor 1 according to the first embodiment includes the shaft 25, the annular rotor core 10 fixed to the shaft 25 and having the magnet insertion hole 11, and the permanent magnet 20 disposed in the magnet insertion hole 11. The rotor core 10 includes the center hole 14 which is formed at the center of the rotor core 10 in the radial direction and in which the shaft 25 is fitted, the plurality of slits 12 formed around the center hole 14 and each elongated in the circumferential direction, the rib 13 formed between adjacent two of the slits 12, and the groove portion 15 formed to extend outward in the radial direction from the center hole 14. The groove portion 15 is located on the inner side of the rib 13 in the radial direction. The width T of the rib 13 in the circumferential direction and the width W of the groove portion 15 in the circumferential direction satisfy T>W.

Since the groove portion 15 is formed on the inner side of the rib 13 in the radial direction as above, the center hole 14 can be uniformly expanded during heating of the rotor core 10 so that the shaft 25 can be easily inserted in the center hole 14. In addition, since the width T of the rib 13 and the width W of the groove portion 15 satisfy T>W, a sufficient contact area is obtained between the shaft 25 and the center hole 14, and thus fitting strength between the rotor core 10 and the shaft 25 can be increased.

Each slit 12 includes the side edge 12c facing the rib 13, the curved corner 121 formed on the inner side of the side edge 12c in the radial direction, and the curved corner 122 formed on the outer side of the side edge 12c in the radial direction, and the radii of curvatures R1 and R2 of the curved corners 121 and 122 satisfy R1>R2. Thus, stress concentration on the inner peripheral core portion 16 during heating of the rotor core 10 can be reduced.

Further, since the radius of curvature R1 of the curved corner 121 and the width L of the slit 12 satisfy R1>L/2, stress concentration on the inner peripheral core portion 16 during heating of the rotor core 10 can be further reduced.

Moreover, since the distance D1 from the center hole 14 to the center of the inner edge 12a of the slit 12 in the circumferential direction and the distance D2 from the center hole 14 to the end of the inner edge 12a of the slit 12 in the circumferential direction satisfy D1<D2, the width of a portion of the inner peripheral core portion 16 on which stress tends to be concentrated most can be increased, and thus stress concentration can be reduced.

Since the rib 13 and the groove portion 15 are located on the inner side of the inter-pole portion M in the radial direction, the heat transfer path from the center hole 14 to the magnet insertion hole 11 can be made the longest, and thus the effect of suppressing demagnetization of the permanent magnet 20 can be enhanced.

The width T of the rib 13 in the circumferential direction increases as the distance to the center hole 14 decreases, and thus stress concentration around the curved corner 121 of the slit 12 in the rotor core 10 can be reduced.

### (Compressor)

Next, a compressor 300 to which the motor 100 is applicable will be described. FIG. 7 is a longitudinal sectional view illustrating the compressor 300 including the motor 100. The compressor 300 is a rotary compressor in this example, but may be a scroll compressor.

The compressor 300 includes a closed container 307, a compression mechanism 301 disposed in the closed container 307, and the motor 100 that drives the compression mechanism 301.

The compression mechanism 301 includes a cylinder 302 including a cylinder chamber 303, a rolling piston 304 fixed to the shaft 25 of the motor 100, a vane dividing the inside of the cylinder chamber 303 into a suction side and a compression side, and an upper frame 305 and a lower frame 306 through which the shaft 25 is inserted and which close end faces of the cylinder chamber 303 in the axial direction. An upper discharge muffler 308 and a lower discharge muffler 309 are respectively attached to the upper frame 305 and the lower frame 306.

The closed container 307 is a cylindrical container. A bottom portion of the closed container 307 stores refrigerating machine oil (not shown) for lubricating sliding portions of the compression mechanism 301. The shaft 25 is rotatably held by the upper frame 305 and the lower frame 306 serving as bearing portions.

The cylinder 302 includes the cylinder chamber 303 therein, and the rolling piston 304 eccentrically rotates in the cylinder chamber 303. The shaft 25 includes an eccentric shaft part, and the rolling piston 304 is fitted to the eccentric shaft part.

The stator 3 of the motor 100 is incorporated in the closed container 307 by a method such as shrink fitting, press fitting, or welding. The coil 35 of the stator 3 is supplied with electric power from a glass terminal 311 fixed to the closed container 307. The shaft 25 is fixed to the rotor core 10 as described above.

An accumulator 310 is attached to the outer side of the closed container 307. A refrigerant gas flows into the accumulator 310 from a refrigerant circuit through a suction pipe 314. In a case where liquid refrigerant flows from the suction pipe 314 together with the refrigerant gas, the liquid refrigerant is stored in the accumulator 310, and the refrigerant gas is supplied to the compressor 300.

A suction pipe 313 is fixed to the closed container 307, and a refrigerant gas is supplied from the accumulator 310 to the cylinder 302 through the suction pipe 313. An upper portion of the closed container 307 includes a discharge pipe 312 for discharging refrigerant to the outside.

As refrigerant of the compressor 300, R410a, R407c, R22 or the like may be used, for example. From the viewpoint of preventing global warming, a refrigerant having a low global warming potential (GWP) is preferably used. As the low-GWP refrigerant, the following refrigerants can be used, for example.

(1) First, halogenated hydrocarbon having a double bond of carbon in its composition, such as hydro-fluoro-olefin (HFO) 1234yf(CF₃CF═CH₂) can be used. HFO-1234yf has a GWP of 4.

(2) Further, hydrocarbon having a double bond of carbon in its composition, such as R1270 (propylene), may be used. R1270 has a GWP of 3, which is smaller than that of HFO-1234yf, but has flammability higher than that of HFO-1234yf.

(3) A mixture containing at least one of halogenated hydrocarbon having a double bond of carbon in its composition or hydrocarbon having a double bond of carbon in its composition, such as a mixture of HFO-1234yf and R32, may be used. Since HFO-1234yf described above is a low-pressure refrigerant, a pressure loss tends to increase, and performance of a refrigeration cycle (especially an evaporator) may degrade. Thus, it is practically preferable to use a mixture with R32 or R41, which is a higher-pressure refrigerant than HFO-1234yf.

Operation of the compressor 300 is as follows. A refrigerant gas supplied from the accumulator 310 is supplied to the cylinder chamber 303 of the cylinder 302 via the suction pipe 313. When the motor 100 is driven by current supplied to the coil 35, the shaft 25 rotates together with the rotor 1. Then, the rolling piston 304 fitted to the shaft 25 eccentrically rotates in the cylinder chamber 303, and refrigerant is compressed in the cylinder chamber 303.

The refrigerant compressed in the cylinder chamber 303 passes through the discharge mufflers 308 and 309, and further passes through a gap between the rotor 1 and the stator 3 or through holes (not shown) to flow upward in the closed container 307. The refrigerant that has flown upward in the closed container 307 is discharged from the discharge pipe 312 and supplied to a high-pressure side of the refrigeration cycle.

In the compressor 300, a torque exerted on the motor 100 pulses by a load fluctuation generated in the compression mechanism 301. A maximum value of torque pulsation exerted on the motor 100 of the compressor 300 is larger than that of a general motor. In the motor 100 according to the first embodiment, fitting strength between the rotor 1 and the shaft 25 is high, and thus the motor 100 can withstand torque pulsation caused by load fluctuation of the compression mechanism 301.

The compressor 300 illustrated in FIG. 7 is a single rotary compressor including a single cylinder 302, but may be a twin rotary compressor including two cylinders with opposite eccentric directions. Reliability of either type of compressor can be enhanced when the motor 100 of the first embodiment is used therein.

Load fluctuation in the single rotary compressor is larger than that in the twin rotary compressor. Thus, the motor 100 of the first embodiment exhibits its advantages especially in the single rotary compressor.

### (Refrigeration Cycle Apparatus)

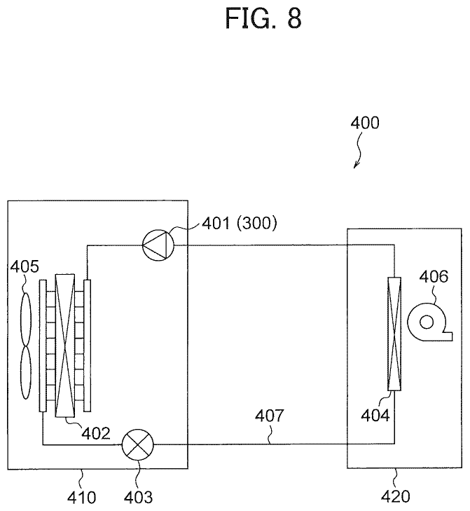

Next, a refrigeration cycle apparatus 400 including the compressor 300 illustrated in FIG. 7 will be described. FIG. 8 is a diagram illustrating the refrigeration cycle apparatus 400. The refrigeration cycle apparatus 400 is, for example, an air conditioner, but is not limited thereto and may be, for example, a refrigerator.

The refrigeration cycle apparatus 400 illustrated in FIG. 8 includes a compressor 401, a condenser 402 that condenses refrigerant, a decompressor 403 that decompresses refrigerant, and an evaporator 404 that evaporates refrigerant. The compressor 401, the condenser 402, and the decompressor 403 are disposed in an outdoor unit 410. The evaporator 404 is disposed in an indoor unit 420.

The compressor 401, the condenser 402, the decompressor 403, and the evaporator 404 are coupled to one another by a

refrigerant pipe 407, and constitute a refrigerant circuit. The Compressor 401 is the compressor 300 illustrated in FIG. 7. The refrigeration cycle apparatus 400 also includes an outdoor fan 405 facing the condenser 402, and an indoor fan 406 facing the evaporator 404.

Operation of the refrigeration cycle apparatus 400 is as follows. The compressor 401 compresses sucked refrigerant and sends out the compressed refrigerant as a high-temperature and high-pressure refrigerant gas. The condenser 402 performs heat exchange between the refrigerant sent from the compressor 401 and outdoor air sent by the outdoor fan 405, condenses the refrigerant, and sends out the condensed refrigerant as liquid refrigerant. The decompressor 403 causes liquid refrigerant sent from the condenser 402 to expand, and sends out the expanded refrigerant as low-temperature and low-pressure liquid refrigerant.

The evaporator 404 performs heat exchange between indoor air and the low-temperature and low-pressure liquid refrigerant sent from the decompressor 403, evaporates the refrigerant, and sends out the refrigerant as a refrigerant gas. Air from which heat is taken by the evaporator 404 is supplied by the indoor fan 406 into a room that is a space to be air-conditioned.

The compressor 401 of the refrigeration cycle apparatus 400 includes the motor 100 according to the first embodiment, and fitting strength between the rotor 1 and the shaft 25 is high. Since the motor 100 sufficiently withstand load fluctuation in the compressor 401, reliability of the refrigeration cycle apparatus 400 can be enhanced.

Although the preferred embodiments have been specifically described above, the present disclosure is not limited to these embodiments, and various improvements and modifications may be made.

1. A rotor comprising:
a shaft,
an annular rotor core fixed to the shaft and having a magnet insertion hole; and
a permanent magnet disposed in the magnet insertion hole,
wherein the rotor core has:
a center hole formed at a center of the rotor core in a radial direction, the shaft being fitted into the center hole;
a plurality of slits formed around the center hole and each elongated in a circumferential direction of the rotor core;
a rib formed between two of the plurality of slits, which are adjacent to each other in the circumferential direction, of the plurality of slits; and
a groove portion formed to extend outward in the radial direction from the center hole,
wherein the groove portion is located on an inner side of the rib in the radial direction,
wherein a width T of the rib in the circumferential direction and a width W of the groove portion in the circumferential direction satisfy T>W, and
wherein the width T of the rib in the circumferential direction increases as a distance to the center hole decreases.

2. The rotor according to claim 1, wherein each of the plurality of slits has:
a side edge facing the rib,
a first curved corner formed on an inner side of the side edge in the radial direction, and
a second curved corner formed on an outer side of the side edge in the radial direction, and
a radius of curvature R1 of the first curved corner and a radius of curvature R2 of the second curved corner satisfy R1>R2.

3. The rotor according to claim 2, wherein each of the plurality of slits has a width L in the radial direction, and
wherein the width L and a radius of curvature R1 of the first curved corner satisfy R1>L/2.

4. The rotor according to claim 1, wherein each of the plurality of slits has an inner edge facing the center hole, and
wherein a distance D from the center hole to a center of the inner edge in the circumferential direction and a distance D2 from the center hole to an end of the inner edge in the circumferential direction satisfy D1<D2.

5. The rotor according to claim 1, wherein the rib and the groove portion are located on an inner side in the radial direction of an inter-pole portion between the magnet insertion hole and another magnet insertion hole adjacent thereto in the circumferential direction.

6. (canceled)

7. The rotor according to claim 1, wherein each of the plurality of slits has a width L in the radial direction, and
wherein the width T of the rib in the circumferential direction is less than or equal to the width L.

8. The rotor according to claim 1, wherein the permanent magnet is a rare earth magnet.

9. A motor comprising:
the rotor according to claim 1; and
a stator surrounding the rotor.

10. A compressor comprising:
the motor according to claim 9; and
a compression mechanism driven by the motor.

11. A refrigeration cycle apparatus comprising the compressor according to claim 10, a condenser, a decompressor, and an evaporator.
